(19) United States
(12) Patent Application Publication
(10) Pub. No.: US 2014/0309475 A1
(43) Pub. Date: Oct. 16, 2014

(54) Waste to Energy By Way of Hydrothermal Decomposition and Resource Recycling

(71) Applicants: Robert Van Naarden, Huntingdon Valley, PA (US); Marco Bonilla, Canton, GA (US); Hans Jasper, Borstel-Hohenraden (DE); Robert Jasper, Geseke (DE); Kuni Yoshikawa, Yokohama (JP); Toshifumi Yamada, Hokkaido (JP); Matthew Song, Seoul (KR)

(72) Inventors: Robert Van Naarden, Huntingdon Valley, PA (US); Marco Bonilla, Canton, GA (US); Hans Jasper, Borstel-Hohenraden (DE); Robert Jasper, Geseke (DE); Kuni Yoshikawa, Yokohama (JP); Toshifumi Yamada, Hokkaido (JP); Matthew Song, Seoul (KR)

(21) Appl. No.: 14/082,905

(22) Filed: Nov. 18, 2013

Related U.S. Application Data
(63) Continuation of application No. 12/954,320, filed on Nov. 24, 2010, now abandoned.

(51) Int. Cl. B09B 3/00; F23G 5/04; F23G 7/00; F23G 5/02

(52) U.S. Cl. CPC B09B 3/0091; F23G 5/02; F23G 5/04; F23G 7/001; F23G 2201/10; F23G 2201/20; F23G 2200/00
USPC 588/317; 110/221; 110/224; 110/215; 110/234; 588/320

(57) ABSTRACT

A method and an apparatus for disposing wastes comprising the steps of conducting a hydrothermal decomposition reaction of the wastes, separating the products into a solid fuel and waste water, combusting the solid fuel, scrubbing the combustion gas, generating steam using the heat generated by the combustion, and purifying the waste water, exhibit a high energy-efficiency, while exhibiting a high removal rate of the pollutants generated during the combustion.

### CROSS-REFERENCE TO RELATED APPLICATIONS

This application is a continuation of U.S. application Ser. No. 12/954,320 filed Nov. 24, 2010, which claims the benefit of U.S. Provisional Application No. 61/264,001, filed Nov. 24, 2009, and is a continuation of International Application No. PCT/KR2010/008237, filed Nov. 22, 2010, both of which are hereby incorporated herein by reference.

### FIELD OF THE INVENTION

The present invention relates to an energy-efficient method for disposing organic wastes such as municipal solid wastes and sewage sludge and an apparatus therefore.

### BACKGROUND OF THE INVENTION

Organic wastes such as sludge, livestock excreta, food discards, and agricultural wastes have been generally disposed by an anaerobic digestion to recover bio gas such as methane. The anaerobic digestion is useful in that the refined methane gas can be used as an energy resource, but it has the problem that the required long process time causes a high cost and the energy efficiency is low.

Most MSWs (municipal solid wastes) are currently disposed by incineration, as landfill becomes restricted for its adverse effect to the environment. The incineration enables the recovery of heat energy, but the process requires expensive fly ash and bottom ash treatment steps.

Recently, a process for disposing organic and solid wastes using hydrothermal decomposition has been developed. However, this process has the problem that the resulting solid fuel product contains a considerable amount of chlorine-generating toxic organic chlorine compounds such as dioxin, which must be removed by a treatment process such as SCR (selective catalytic reduction) when such solid fuel is used. For this reason the waste to energy system is not economically feasible when compared with the conventional incineration process. Further, the solid fuel obtained by the hydrothermal decomposition process produces dust and various air pollutants when burned using a conventional incineration process, although the dust problem can be partially solved by pelletizing the solid fuel.

The conventional hydrothermal decomposition product is separated into a solid fuel and waste water by centrifugation, followed by treating the waste water in a sewage disposal plant, but such waste water has a BOD value of about 40,000 mg/L and CODcr of about 50,000 mg/L, which may not be effectively treated in the sewage disposal plant.

Also, most conventional processes for treating exhaust gases use a dry scrubber which is generally used in a sulfur removal process, but the exhaust gas generated during the combustion of said solid fuel contains pollutants such as HCl, NOx which are difficult to remove by the dry scrubber. Therefore, a wet scrubber or a combination with a dry scrubber is needed.

### SUMMARY OF THE INVENTION

Accordingly, it is an object of the present invention to provide a high energy-efficiency, integrated method for disposing wastes containing organic components, and an apparatus therefor.

In accordance with an aspect of the present invention, there is provided a method for disposing wastes comprising the steps of: (a) conducting a hydrothermal decomposition reaction of the wastes using 170-250° C. and 18-25 bar steam; (b) separating the product of step (a) into a liquid residue and a solid product using gravity, centrifuging, or applied pressure; (c) drying the solid product separated in step (b) to obtain a solid fuel; (d) combusting the solid fuel obtained in step (c); (e) scrubbing the combustion gas generated in step (d); (f) generating 170-250° C. and 18-25 bar steam to be supplied to step (a), by using the heat generated in step (d); and (g) purifying the separated liquid residue in step (b), followed by discharging.

In accordance with another aspect of the present invention, there is provided an apparatus for disposing wastes comprising: (a) a reactor for hydrothermally treating the wastes with 170-250° C. and 18-25 bar steam; (b) a separator for separating the product of the reactor (a) into a liquid residue and a solid product by using gravity, centrifuging, or applied pressure; (c) a dryer for drying the solid product separated in the separator (b) to obtain a solid fuel; (d) a combustion chamber for combusting the solid fuel obtained in the dryer (c); (e) a scrubber for scrubbing the combustion gas generated in the combustion chamber (d); (f) a boiler for generating 170-250° C. and 18-25 bar steam to be supplied to the reactor (a) by using the heat generated in the combustion chamber (d); and (g) a purifier for purifying the liquid separated in the separator (b), followed by discharging.

The inventive method and apparatus for disposing waste by way of an integrated system of hydrothermal decomposition and resource recycling, exhibit highly energy-efficient, while exhibiting a high removal rate of the pollutants generated during the combustion. The present invention is useful for disposing wastes comprising municipal solid wastes, sewage or waste water sludge, livestock excreta, food discard, and agricultural waste.

### BRIEF DESCRIPTION OF THE DRAWINGS

The above and other objects and features of the present invention will become apparent from the following description of the invention, when taken in conjunction with the accompanying drawings, which respectively show:

FIG. 1: a block diagram showing an example of the waste treatment process according to the present invention; and

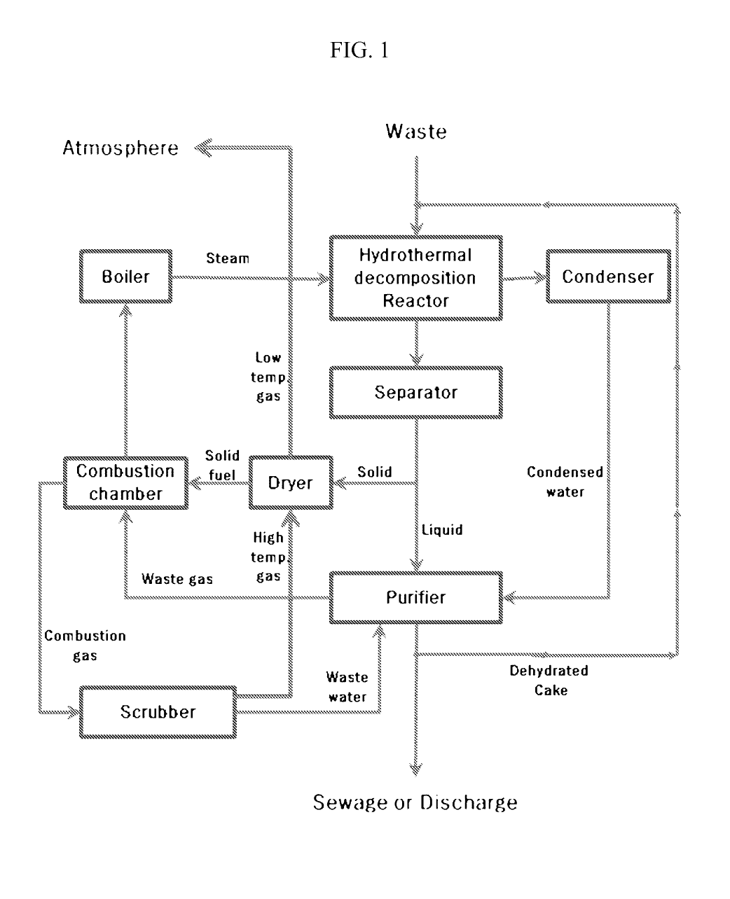

FIG. 2: a block diagram showing another example of the waste treatment process according to the present invention.

### DETAILED DESCRIPTION OF THE INVENTION

In the present invention, the term “wastes” as used herein comprises organic wastes such as municipal solid wastes containing organic components, sewage or waste water sludge, livestock excreta, food discards, agricultural wastes, and a mixture thereof.

Hereinafter, the process according to the present invention is described in detail by the following example but it is provided only for illustrations and the present invention is not limited thereto.

### Hydrothermal Decomposition Reaction

Wastes containing organic components are supplied into a reactor (pressure vessel) through the inlet.

Then, 170-250° C. and 18-25 bar steam is supplied into the reactor together with mechanical stirring via rotational blades. This steam is generated from the boiler. After reaching 170-250° C. in the reactor, this condition is held for 20-90 minutes by supplying steam. The condition of the hydrothermal decomposition reaction is more preferably 190-215° C. and 19-22 bar.

When the condition falls within the above range, more organic chlorine in the wastes can be decomposed and reacted with alkali components in the wastes to produce an organic chlorine salt, which can reduce the amounts of HCl and dioxin generated from combustion of the solid waste. Further, more amounts of nitrogen and sulfur in the wastes can be evaporated, transported through condensed water, or dissolved in liquid phase, which can reduce the amounts of NOx and SOx generated from the combustion of the solid waste.

The reactor used in the present invention may be preferably a batch reactor.

The hydrothermal decomposition reaction may be conducted in the presence of one or more metals selected from the group consisting of Ca, Mg, K, and Na in the form of oxide, hydroxide, or carbonate, so as to increase a removal rate of chlorine in solid phase of the waste.

These metal components easily dissolve in water and give electrons to electrophilic chlorine atom in solid phase, allowing the chlorine to be present as stable anion as shown in Reaction scheme 1 below. The electron-rich chlorine anions can pair with cations such as calcium and magnesium, enabling the chlorine to move into liquid phase from solid phase.

—C—C—C—C(—Cl)—C—+CaCO₃→—C—C—C—C—C—+Cl⁻+Ca²⁺ Reaction scheme 1

For example, when a plastic waste containing 3.4 wt % of organic chlorine and 0 wt % of inorganic chlorine in solid phase is treated as shown in Reaction scheme 1, it is possible to decrease the content of the organic chlorine to below 0.2% and to increase the content of the inorganic chlorine to around 2 wt %.

As above, the chlorine anions (Cl⁻) in liquid phase may exist in the dissolved state during condensation or purifying process and can be disposed environmentally safely discharged into nature water system or sewage disposal plant without generating toxic organic chlorine compounds such as dioxin.

Moreover, the combustion of a solid residue obtained in the hydrothermal decomposition hardly generates organic chlorine compounds such as dioxin, which can simplify process for treating exhaust gas.

When the hydrothermal decomposition is complete, the supply of steam is stopped and the steam within the reactor is discharged into the condenser.

After reducing the pressure inside of the reactor down to atmospheric, the product is discharged from the reactor and is sent to the separator (dehydrator.)

The product may be in the form of wet solid or slurry like liquid with 70-90% of water content.

### Condensation

The steam inside of the reactor is transported into the condenser and condensed by passing through the condensing tube having a temperature of 100° C. or less.

The condensed water may contain VOCs (Volatile Organic Compounds: source of bad smell) and have BOD and COD values in the range of 2000-6000 mg/L.

The condensed water is sent to the purifier.

### Solid-Liquid Separation

The product obtained from the hydrothermal decomposition reaction is sent to the separator (dehydrator) and is separated into the solid product and the liquid residue by mechanical dehydration using gravity, centrifuging, or applied pressure to obtain solid residue whose water content is around 40-70%.

The solid product is sent to the dryer and the liquid residue is to the purifier.

### Drying

The solid product separated in the separator is further dehydrated in the dryer using hot air by 10-30% of water content level to produce a solid fuel.

Preferably, the hot exhaust gas coming out from the scrubber is used as drying air for maximizing the thermal efficiency. Through the drying process, the hot air supplied from the scrubber has the temperature reduced and the low temperature air is discharged into the atmosphere.

Therefore, the present invention can reduce air pollution by lowering the temperature of the exhaust gas and exhibit high energy efficiency by recycling the heat from the combustion.

The solid fuel obtained by the drying process is transported into the combustion chamber.

### Combustion of Solid Fuel

The solid fuel obtained in the dryer is completely burned off in the combustion chamber. Preferably, waste gases containing VOCs and ammonia coming out of the entire process, particularly purifying process, are supplied into the combustion chamber and are combusted together with the dried solid fuel so as to remove off-flavor components.

The temperature for combustion is preferably 850-1,200° C. The burner system is only for start up and the high temperature for combustion is maintained by the heating value of the input material.

With a control system installed inside the combustion chamber the thermal process may be assisted and the moving of the ash to the discharging can be controlled. For safe monitoring a high temperature camera system may be installed and an optimum condition for combustion can be calculated thereby so that the process get low dust emission and low pollutant emissions like NOx in the off gas. Due to this design, the dried solid fuel may be combusted without the need of pelletizing.

The ash is discharged out and the combustion gas containing CO₂, CO, NOx, SOx and heavy metals is transported to the scrubber.

The heat generated from the combustion is supplied into the boiler.

### Steam Generation

A heat generated from the combustion chamber is supplied into the boiler to generate the steam of 170-250° C. and 18-25 bar, and the steam is supplied into the hydrothermal decomposition reactor.

### Gas Scrubbing

The combustion gas coming out of the combustion chamber is supplied into the scrubber to remove the pollutants to well below the standard level.

Preferably, the pollutants to be removed through the scrubber are particulates such as dust and heavy metals and gaseous pollutants such as HCl, CO₂, CO, NOx and SOx which may cause air pollution.

The pollutants in the gas can be treated by the following wet scrubbing processes.
i) 3-stage wet scrubbing process

The combustion gas may be treated by 3-stage scrubbing process using acidic scrubber, neutral scrubber, and basic scrubber.

Bad smelling gas→[acidic scrubber]→[neutral scrubber]→[basic scrubber]→clean gas
Basic pollutants (NH₃, (CH₃)₃N): treatment with H₂SO₄ or HCl
   2NH₃+H₂SO₄→(NH₄)₂SO₄
   NH₃+HCl→NH₄Cl
   (CH₃)₃N+H₂SO₄→(CH₃)₃N₂.H₂SO₄
   (CH₃)₃N+HCl→(CH₃)₃N.Cl
Acidic pollutants (H₂S) : treatment with NaOH
   H₂S+2NaOH→Na₂S+2H₂O
Neutral pollutants (CH₃)₂S, (CH₃)₂S₂)
   (CH₃)₂S+O₂→(CH₃)₂SO
   (CH₃)₂S₂+O₂→(CH₃)SO₃H
Other pollutants can be removed by absorption.
ii) 2-stage web scrubbing process

Moreover, the combustion gas coming out of the combustion chamber may be treated by 2-stage scrubbing process using ozone and alkali, which allows a compact system configuration and thus the process can be simplified and the area for scrubbing can be reduced. The ozone oxidizing scrubber and the alkali scrubber synergistically remove pollutants in the combustion gas.

Bad smelling gas→[ozone oxidizing scrubber]→[alkali scrubber]→clean gas

Ozone Oxidizing Scrubbing Process
Basic pollutants (NH₃, (CH₃)₃N)
   2NH₃+3O₃→N₂+3H₂O+3O₂
   (CH₃)₃N+3O₃→CH₂NO₂+2CO₂+3H₂O
Acidic Pollutants (H₂S)
   H₂S+O₃→SO₂+H₂O, 3H₂S+4O₃→3H₂SO₄
Neutral Pollutants (CH₃)₂S, (CH₃)₂S₂)
   3(CH₃)₂S+₃ →(CH₃)₂SO, (CH₃)₂S+O₃→(CH₃)₂SO₃
   2(CH₃)₂S₂+H₂O+O₃→2CH₃SO₃H, 3(CH₃)₂S₂+5O₃→3(CH₃)₂S₂O₅

Alkali Scrubbing Process
HCl (removal rate: 95-98%)
   2NaOH+CO₂→Na₂CO₃+H₂O
   Na₂CO₃+CO₂→NaCO₃+CO₂
   Na₂CO₃+2HCl→2NaCl+H₂O+CO₂
SOx (removal rate: 95-98%)
   Na₂SO₃+SO₂+H₂O→2NaHSO₃
   Na₂SO₃+1/2O₂→Na₂SO₄
NOx (NO, NO₂) (removal rate: 90-95%)
   NO+oxidizer→NO₂+oxidizer (reduced)
   2NO₂ +H₂O→HNO₃+HNO₂

As described above, the scrubber in the present invention comprises a dry scrubber and a wet scrubber which conducts 3- or 2-stage scrubbing process depending on pollutants, thereby providing an optimum process and treating various pollutants effectively.

The waste water coming out of the scrubber is sent to the purifier (waste water treatment facility.)

### Purification (Waste Water Treatment)

The liquid separated from the separator, the condensed water passed through the condenser, and the waste water coming out of the scrubber are all transported into the purifier (waste water treatment facility) to be cleaned to a dischargeable level.

The condensed water obtained by condensing the steam generated from the hydrothermal decomposition reaction, has relatively low BOD and COD values, i.e., about 5000 mg/L and 6000 mg/L, respectively, which are disposable level in the sewage disposal plant. However, the liquid separated from the separator (dehydrator) has 40,000 mg/L of BOD and 50,000 mg/L of CODcr, which can disturb sewage disposal process.

Accordingly, the present invention comprises a purification process for treating high concentration of organic waste water to a safe level, which makes it possible to discharge the treated water directly into nature water system such as river or lake or into a sewage disposal plant.

In the purifier, high concentration of organic waste water is effectively treated using microorganism in a high oxygen transfer rate.

Based on the following equation that gas dissolves in liquid in proportion to the pressure at a constant temperature, gases can dissolve at a maximum rate by controlling the pressure. An aeration tank in the purifier is excellent at supplying DO (dissolved oxygen) to aerobic microorganism.

P=k_{H}·C

wherein, P is the gas pressure (atm), k_{H} is the Henry's law constant (L·atm/mol), and C is the gas solubility (mol/L.)

By supplying enough DO as above, high concentration (8,000˜20,000 mg/L) of MLSS (mixed liquor suspended solids) is maintained so that the reactivity increases (MLSS≈reactivity), allowing to a compact facility whose size is below ⅕ of that of a conventional aeration tank while having an optimum level of performance.

The resulting water treated in the purifier may be further treated by the following processes: 1st solid-liquid separation→high efficient reaction (treatment of waste water)→2nd solid-liquid separation, so that the resulting water has 500˜3,000 mg/L of BOD, 500˜3,000 mg/L of COD, 500˜2,000 mg/L of T-N, and 10-500 mg/L of T-P, which are dischargeable level into a sewage disposal plant.

In the case where the treated water is discharged directly into nature such as a river, processes for denitrification and dephosphorization may be added as the following processes: dehydration→anaerobic reaction→denitrification→high efficient reaction→precipitation→advanced treatment, so as to meet the requirement for the dischargeable level into nature.

The purification process may leave a dehydrated solid cake, which is re-transported into a hydrothermal decomposition reactor to be treated together with other wastes.

### Electricity Generation

The present invention may be further comprises an additional boiler and a generator.

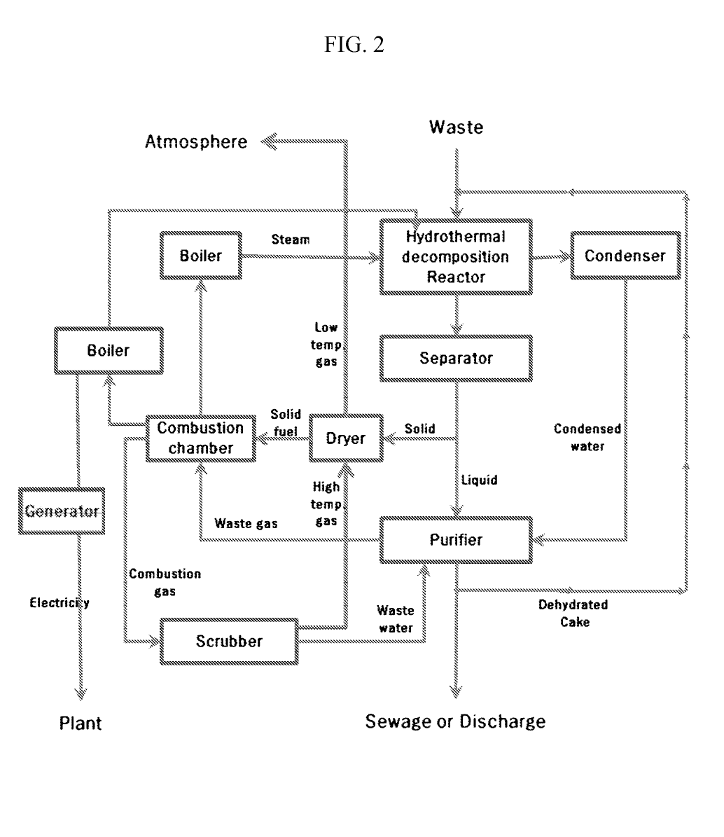

A part of heat generated in the combustion chamber may be supplied into the additional boiler (waste heat boiler) and the steam generated therefrom may be transported into the generator to generate electricity to be supplied into plants (see FIG. 2.)

The extra steam may be supplied to the hydrothermal decomposition reactor.

While the invention has been described with respect to the above specific embodiments, it should be recognized that various modifications and changes may be made to the invention by those skilled in the art which also fall within the scope of the invention as defined by the appended claims.

What is claimed is:

1. A method for disposing wastes comprising the steps of:
(a) conducting a hydrothermal decomposition reaction of the wastes using 170-250° C. and 18-25 bar steam;
(b) separating the product of step (a) into a liquid residue and a solid product using gravity, centrifuging, or applied pressure;
(c) drying the solid product separated in step (b) to obtain a solid fuel;
(d) combusting the solid fuel obtained in step (c);
(e) scrubbing the combustion gas generated in step (d);
(f) generating 170-250° C. and 18-25 bar steam to be supplied to step (a), by using the heat generated in step (d); and
(g) purifying the separated liquid residue in step (b), followed by discharging.

2. The method of claim 1, wherein the hydrothermal decomposition reaction of step
(a) is conducted in the presence of one or more metals selected from the group consisting of Ca, Mg, K, and Na in the form of oxide, hydroxide, or carbonate.

3. The method of claim 1, wherein the scrubbing step (e) is conducted by dry scrubbing; wet scrubbing using at least one selected from the group consisting of H₂SO₄, HCl, NaOH, (CH₃)₂S, (CH₃)₂S₂, Na₂SO₃; and O₃; or a combination thereof.

4. The method of claim 1, wherein the scrubbing step (e) removes one or more pollutants selected from the group consisting of HCl, CO₂, CO, NOx, SOx, and heavy metals.

5. The method of claim 1, wherein the exhaust gas generated in step (e) is used in step (c) as drying air before releasing into the atmosphere.

6. The method of claim 1, which further comprises the step of generating electricity using the steam which is produced using the heat generated in step (d).

7. The method of claim 1, wherein the wastes comprise municipal solid wastes containing organic components, sewage or waste water sludge, livestock excreta, food discards, agricultural wastes, or a mixture thereof.

8. An apparatus for disposing wastes comprising:
(a) a reactor for hydrothermally treating the wastes with 170-250° C. and 18-25 bar steam;
(b) a separator for separating the product of the reactor (a) into a liquid residue and a solid product by using gravity, centrifuging, or applied pressure;
(c) a dryer for drying the solid product separated in the separator (b) to obtain a solid fuel;
(d) a combustion chamber for combusting the solid fuel obtained in the dryer (c);
(e) a scrubber for scrubbing the combustion gas generated in the combustion chamber (d);
(f) a boiler for generating 170-250° C. and 18-25 bar steam to be supplied to the reactor (a) by using the heat generated in the combustion chamber (d); and
(g) a purifier for purifying the liquid separated in the separator (b), followed by discharging.

9. The apparatus of claim 8, wherein the reactor (a) performs the hydrothermal decomposition process in the presence of one or more metals selected from the group consisting of Ca, Mg, K, and Na in the form of oxide, hydroxide, or carbonate.

10. The apparatus of claim 8, wherein the scrubber (e) conducts dry scrubbing; wet scrubbing using at least one selected from the group consisting of H₂SO₄, HCl, NaOH, (CH₃)₂S, (CH₃)₂S₂, Na₂SO₃, and O₃; or a combination thereof.

11. The apparatus of claim 8, wherein the scrubber (e) removes one or more pollutants selected from the group consisting of HCl, CO₂, CO, NOx, SOx, andheavy metals.

12. The apparatus of claim 8, wherein the exhaust gas coming out of the scrubber (e) is supplied to the dryer (c) for using as drying air before releasing into the atmosphere.

13. The apparatus of claim 8, which further comprises an additional boiler for generating steam by using the heat generated in the combustion chamber (d);
and a generator for generating electricity by using the steam.

14. The apparatus of claim 8, wherein the wastes comprise municipal solid wastes containing organic components, sewage or waste water sludge, livestock excreta, food discard, agricultural waste, or a mixture thereof.
